(19) United States
(12) Patent Application Publication
(10) Pub. No.: US 2008/0254413 A1
(43) Pub. Date: Oct. 16, 2008

(54) PROCESS FOR THE PRODUCTION OF A HEAD PIECE OF A TOOTH IMPLANT AND MANUFACTURING KIT FOR SUCH A PROCESS

(75) Inventor: Peter GAMPERT, Stein a. d. Traun (DE)

Correspondence Address: DENNISON, SCHULTZ & MACDONALD, 1727 KING STREET, SUITE 105, ALEXANDRIA, VA, 22314, US

(73) Assignee: DEGUDENT GMBH, Hanau (DE)

(21) Appl. No.: 11/870,600

(22) Filed: Oct. 11, 2007

(30) Foreign Application Priority Data
Oct. 20, 2006 (DE) 10 2006 050 457.7

(51) Int. Cl. A61C 5/10

(52) U.S. Cl. 433/223

(57) ABSTRACT

A process for manufacturing a head piece (1) of a tooth implant from an individually produced positive model (27). The head piece (1) is fitted with a plug-in type connection shaped with form-closure (7) as an anti-twist feature and can be inserted into the base (3) which in turn can be embedded in the jawbone. On either head piece or base there is a lug (5) which fits snugly into a socket on the other part. The process calls for copy-milling (V) in which the outer surface of the positive model (27) is three-dimensionally scanned. The data from the scan are used to guide a milling machine which creates the head piece (1) from a ceramic blank (29). In accordance with the invention, before the copy-milling (V) of the blank (29), a preparatory step (I) in the production process is conducted. When the blank is yet in its raw form, the insertion connector with the form-closure (7) connection is shaped ahead of by attaching a scanning insert on the positive model (27) at a point matching the position of the insertion connector on the blank, which enlarges the positive model by at least as much space (a) as that to be occupied by the insertion connector.

### BACKGROUND OF THE INVENTION

The invention consists of a process to manufacture the head piece of a tooth implant from an individually produced positive model. The tooth implant consists of a head piece and a base. The base must be first firmly attached to the jawbone. The head piece is attached to the base by insertion of a lug projecting either from the head piece or from the base and matching a closely fitting socket on the other part. The lug and socket are shaped with a form-closure contour as an anti-twist feature. The head pieces can be made singly. In the process the outer surface of a positive three-dimensional model of the implant is scanned and a ceramic blank is then copy-milled in accordance with the scan data to make the head piece.

The invention comprises likewise a kit for the manufacture of the head piece of tooth implant from an individually fitted positive model by means of a copy-milling machine.

Tooth implants designed to replace teeth usually consist on the one hand of a cylindrical metal base inserted into a drill hole in the jawbone, containing a socket with its opening at the coronal end and oriented roughly along the longitudinal axis of the cylindrical base. The interior surface of the socket is shaped to form a form-closure as an anti-twist feature. A head piece can follow, fitted with a lug shaped to match the form-closure of the socket of the base part and fits snugly into the socket without twisting. The head piece can be made of ceramic material, especially zirconium oxide, and for cosmetic reasons be faced with ceramic or plastic, at least if located in the front of the mouth.

A tooth implant designed in this manner is known from DE-A-10 2006 011 800, in which the lower part of the head piece is has a form closure in the form of its octagonal shape. The base cylinder has a socket open to the coronal end with an octagonal cross-section fitting the lug in the head piece. The fit must be very snug indeed. This guarantees that the head piece will have no play and will be locked against twisting motion and that no external fissure appears at the place where the two parts connect.

It is further common knowledge that manufacture of frameworks of tooth replacements, especially for tooth crowns and/or bridges designed to be attached to natural and/or artificial tooth stumps and the like, can be accomplished by copy-milling as is shown for example in WO-A-03/007834. The procedure is for the dental technician to make by hand a waxen cast of the area in the oral cavity where the implant will be attached and use the cast as a positive model to be scanned three-dimensionally in a machine designed for copy-milling, producing digital data. With the aid of the digitalized positive model a blank piece is then milled on a machine-tool into the desired shape of the tooth replacement.

In view of its imprecision, the copy-milling process can be used only for dental parts with no critical role to play, such as crowns. On the other, hand a head piece like that described above demands much smaller tolerances.

DE-U-203 07 643 describes an auxiliary part used in modeling. The part is designed for implants and made of plastic or wax with plastic-like properties.

The subject matter of EP-A-1 062 916 is a process for manufacturing individually tooth replacements to be affixed by means of an implant. The tooth replacement consists of an implant, a positioning device with an abutment and a supraconstruction. Tooth restorations with prefabricated components such as bracings can be seen in, for example, U.S. Pat. No. 5,674,069, U.S. Pat. No. 6,231,342, U.S. Pat. No. 5,989,029, EP-B-O 891 163, U.S. Pat. No. 5,527,182, U.S. Pat. No. 6,283,753, EP-B-0 891 163 or WO-A-99/62422.

### SUMMARY OF THE INVENTION

The purpose of the invention is to provide a process for manufacturing a head piece for a tooth implant or a kit for accomplishing same that allows a simple and economical manufacture of the head piece.

This is accomplished by means of a process as described at the beginning, namely that before the copy-milling of the ceramic blank, it is fitted with a form-closure plug-type connection and a scanning insert is attached to the positive model in a position matching the ceramic blank's plug connector. The insert lengthens the positive model by at least the length of the connector.

The task can also be accomplished by using a kit for the manufacture of the head piece of a tooth implant from an individually made positive model by means of a copy-milling machine, particularly according to some of the above claims. The head piece can be inserted by means of a plug-type device provided with form closure as an anti-twist feature, into a base part that can be embedded in the jawbone. The manufacturing kit contains a pre-milled ceramic blank from which the head piece can be manufactured using a copy-milling machine on the basis of the positive model, and on which ceramic blank the insertion connector is fashioned independently of the copy-milling step and before it, to obtain a very close fit.

In accordance with the process proposed by the invention, even before the actual copy-milling step, the insertion connector is fashioned, assuring a very close fit, on the as yet unprocessed ceramic blank. In this manner the ceramic blank can be milled, for example on a CNC milling machine, before the copy-milling takes place, thus providing the lug with the requisite form-locking shape at very low tolerances. In parallel fashion, in accordance with the invention a scanning insert is attached to the positive model at the location of the lug on the blank. The insert enlarges the positive model by at least the space taken up by the lug. The scanning insert must be large enough to assure that the preformed lug is not affected by the milling machine. Consequently for the copy-milling process not only the outer surface of the positive model is scanned (whether optically or mechanically) by the copy-milling device, but also the surface of the scanning insert. As a result, the milling machine is prevented from approaching or touching the ceramic blank over the entire area occupied by the pre-shaped lug. The remaining parts of the individually fitted positive model are milled in the usual manner.

By means of this process proposed by the invention, the field of application of already existing copy-milling machines can be expanded from their current function of producing merely high-tolerance parts, e.g. dental crowns or bridges, to making parts requiring great precision like individually fitted head pieces. Accordingly, the capacity of already existing copy-milling machine tools will be better occupied, since their range of products will extend to head pieces for tooth replacements.

For the production of the individually adapted positive model, the constraints of production may require that the positive model be designed with a longitudinal borehole. By means of the lengthwise borehole the dental technician can fasten the positive model with a screw to a model reproducing the surrounding teeth in the patient's mouth and adapt the positive model to such surrounding teeth. The longitudinal hole through the positive model matches the longitudinal hole through the head piece for the purpose of attaching it to the base inserted into the jawbone.

In accordance with the invention, aforesaid longitudinal hole through the positive model can serve to center the positive model in a reference position within a holding frame of the copy-milling machine. For this purpose the invention calls for a centering template with a centering pin that can be inserted through the lengthwise borehole of the positive model until it reaches an upper stop. Then the template is placed on the holding frame with the positive model, which is centered both radially and axially, and oriented in the reference position.

In a further step the dental technician fixes the pre-placed positive model in the reference position with pins and removes the template from the positive model.

Once the positive model is thus fixed in the reference position in the copy-milling machine, the scanning insert in the form of a blank stopper is pressed into the longitudinal borehole of the positive model and held in place. Then the three-dimensional measurement and digitalization of the positive model can begin in preparation for the machining of the already pre-milled ceramic blank.

The ceramic blank is held in the same position as the positive model, with its longitudinal borehole in reference position matching the reference position of the positive model.

Once the shaping of the ceramic blank in the copy-milling machine has concluded, the ceramic blank is sintered in the usual fashion. Consequently the ceramic blank, if pre-sintered, must be worked taking into account the shrinkage that takes place during sintering.

When gathering the data about the outer surface of the positive model, the control program of the copy-milling device performs a linear enlargement in all three dimensions to compensate for the sintering shrinkage of the ceramic blank.

To carry out the process described above, a manufacturing kit can be made in accordance with the invention which includes aforesaid pre-milled ceramic blank from which then the head piece is made by milling in accordance with the data on the positive model. As mentioned above, the pre-shaped ceramic blank in the manufacturing kit has already been equipped with the insertion connector with its longitudinal borehole, by turning or drilling it for example on a CNC lathe within very tight tolerances.

Furthermore, the manufacturing kit can include aforesaid scanning insert that, as explained above, lengthens the positive model by at least the amount of space taken up by the pre-milled insertion connector on the ceramic blank, naturally in a completely sintered state.

Independently thereof, the connector on the blank can match a pre-manufactured rim or collar. The size of the surface of connector and rim or collar in the lengthwise axis of the connector and in a completely sintered state is less than the surface of the scanning insert.

An additional accessory for the kit could be the centering template mentioned above, with whose aid the positive model can be positioned in the holding frame of the copy-milling machine in a certain reference position determined beforehand.

### BRIEF DESCRIPTION OF THE DRAWINGS

Additional details, advantages and characteristics of the invention result not only from the claims and the traits that can be concluded from the claims by themselves and/or in combination, but also from the preferred variants included in following description of the drawings.

They show:

FIG. 1—In a cutaway view from the side a finished head piece of a tooth implant together with a corresponding screwed-in base part of the tooth implant in an exploded view,

FIG. 2—A simplified schematic of the operating position of the positive model and a corresponding ceramic blank in accordance with the invention, in a copy-milling machine,

FIGS. 3 and 4—Two cutaway views seen from the side of the ceramic blank in different steps of machining,

FIG. 5—The positive model with a scanning insert,

FIG. 6—A block diagram with the steps in processing of the head piece,

FIG. 7—An additional variant of a ceramic blank, and

FIG. 8—A scanning insert in the form of a cap.

### DESCRIPTION OF THE PREFERRED EMBODIMENTS

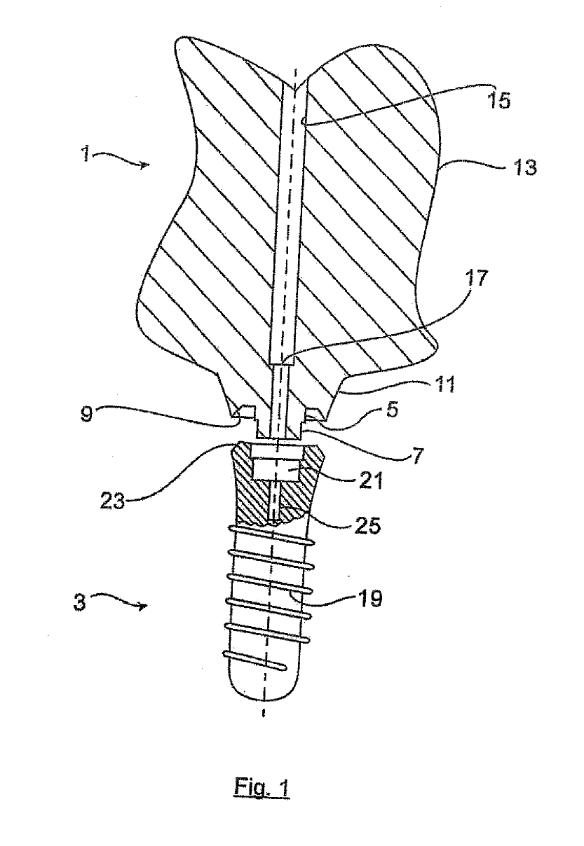

FIG. 1 shows as components of a tooth implant a head piece 1 of zirconium oxide (ZrO₂) and a corresponding screw-in part of the tooth implant 3. The head piece 1 has in its lower part a cylindrical insertion lug 5, on which further along the axis is located a form-closure of an anti-twist configuration showing the example of an octagonal cross-section 7. A concavity forms an abutment rim 9. The abutment rim 9 is located on a truncated cone 11 with a larger radius than the lug 5. Further upward along the axis is the individualized configuration 13, in this example in the shape of a molar.

The head piece 1 surrounds a central longitudinal borehole 15 with a ledge 17 designed to support the head of a screw (not shown) with which to attach the head piece 1 to the screwed-in base part 3.

As can also be seen in FIG. 1, the screwed-in base part 3 is has an outer thread 19 for screwing the base part into a borehole in the jawbone in conventional fashion. The screwed-in base part 3 has a socket 21 at its coronal end that acts as the negative shape for a form-closure plug-type connection which in this instance is the insertion lug 5.

On the frontal coronal rim of the screwed-in base part 3 is a an abutment shoulder 23 that drops off outward at a slant and with which the abutment rim 9 of the head piece 1 can connect in form closure and without displaying any chinks. For purposes of axial fastening and locking, aforesaid screw (not shown) is passed through the longitudinal borehole 15 and screwed into the cylindrical borehole 25 at the base of the socket 21. The screw head rests on the ledge 17 in the longitudinal borehole 15.

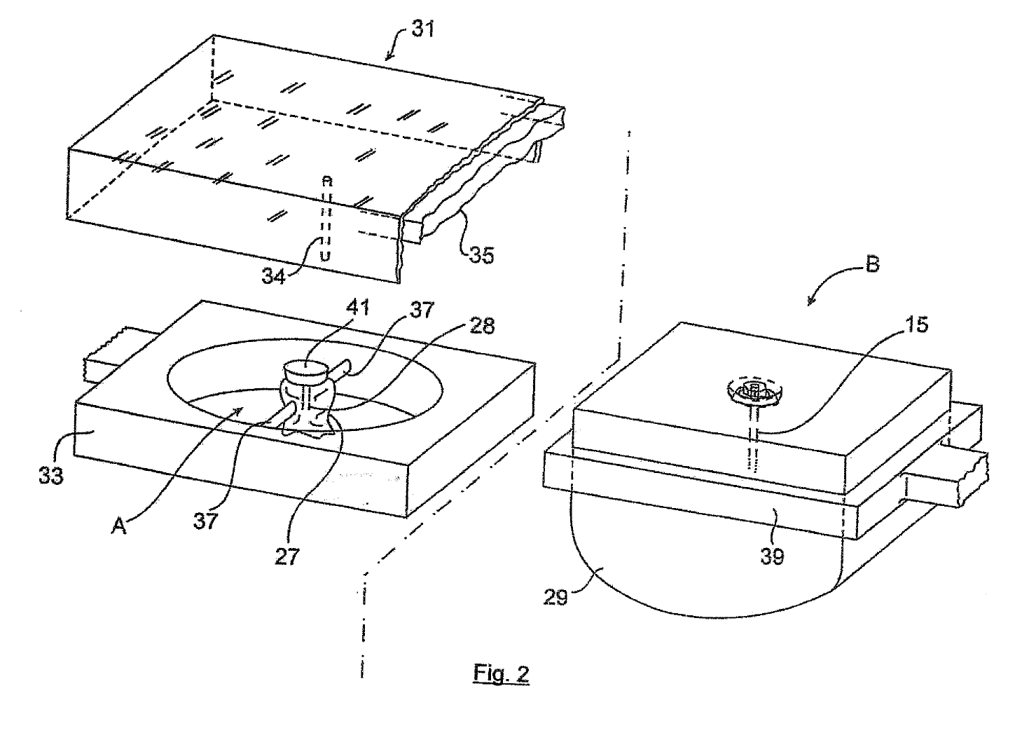

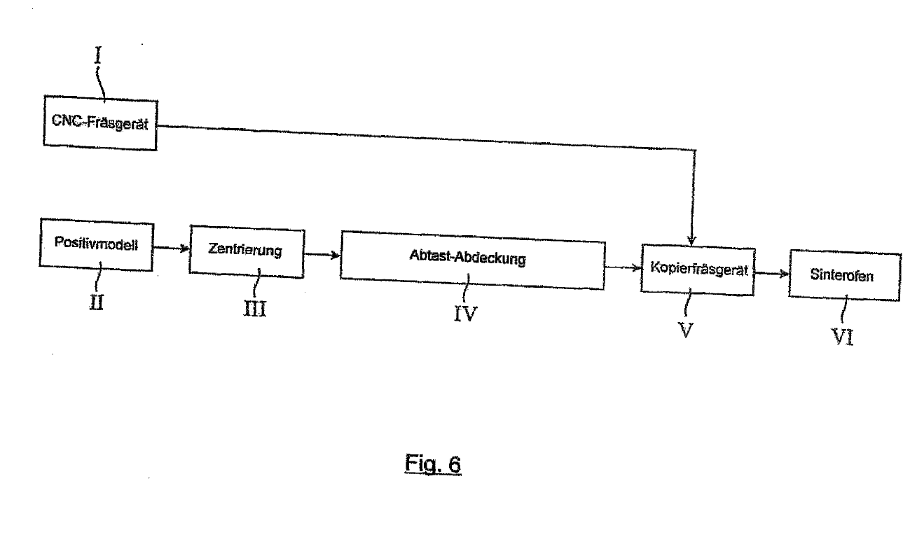

In the following FIGS. 2 to 6, the process is shown for manufacturing the head piece 1 of the tooth implant from an individual positive model 27 made by the dental technician, for example a waxen model like the one shown in FIG. 5.

As can be seen in the block diagram according to FIG. 6, in a preparatory processing step I an as-yet unmachined and unsintered blank 29, made for example from zirconium oxide, is milled in a CNC milling machine. The pre-processed blank 29 is shown in FIG. 3. During this pre-milling step the matter of the blank 29 indicated by a dotted line is removed by the milling machine leaving the conical shape 11 together with the insertion lug 5 at the base of the blank 29. In pre-processing step I, the unsintered blank 29 is perforated by the longitudinal borehole 15 which passes through the center of the cone 11 and is fitted with the ledge 17.

Independently of the pre-processing step I, in the modeling step II as in FIG. 6, the positive model 27 is made by hand in accordance with the previous description of the surrounding teeth made by the dental technician.

In order to shape the positive model 27 in accordance with the patient's requirements, it is fastened with a screw to a model (not shown) representing the patient's jaw and the neighboring teeth. There follows a manual adjustment of the positive model 27 to the surrounding teeth.

Then in a centering step the positive model 27 is centered with its longitudinal borehole 15 with the aid of a centering template 31 in a reference position A within the holding frame 33 of a copy-milling machine (not shown). FIG. 2 shows the holding frame 33 with the positive model 27 in reference position A, as well as the blank 29 already in operating position in the milling machine.

In the centering step III the positive model 27 with its lengthwise borehole 29 is first placed on a centering pin 34 of the template 31 and pushed into a predetermined position up to an upper stop 35. Then the centering template 31 together with the positive model 27 is placed on the holding frame 33, so that the positive model 27 is oriented in the predetermined reference position A within the holding frame 33. Then the positive model 27 which is in its reference position, is fixed with 2 retaining pins 37 (shown) within the holding frame 33. Analogously, the already pre-milled ceramic blank 29, which is inside a holding frame 39, is oriented and immobilized in a reference position B that corresponds to the reference position of the positive model 27, thus guaranteeing a precise milling of the zirconium blank 29.

In a subsequent masking step IV a scanning insert 41 in the form of a blank stopper is pushed into the lengthwise borehole 28 of the modeled positive model 27, as shown in FIG. 5. In the figure the blank stopper 41 has in its center a cylindrical anchoring extension 43 which as shown in FIG. 5 is inserted in the lengthwise borehole 28 to immobilize the blank stopper 41.

As indicated by the dotted line in FIG. 5, the blank stopper 41 on the positive model 27 is located at the position corresponding to that of the insertion connector that was shaped on the ceramic blank 29 in the preparatory milling step I. The blank stopper 41 enlarges the size of the positive model 27 by a space at least equal to the volume of the insertion connector previously added to the blank after it was sintered. In FIG. 2 the blank 29 is portrayed in such a way as to indicate the possibility that the blank stopper 41 (indicated with a dotted line) occupies approximately the same volume as the previously fashioned insertion connector.

In this manner during the subsequent copy-milling step V not only the outer surface of the positive model 27 is scanned and digitalized but also the outer surface of the blank stopper 41. Consequently, the cutting tool of the copy-milling device will be kept at a distance a from the ceramic blank 29 and pass over the already preshaped insertion connector without touching it. The remaining portions of the individually produced positive model 27 are on the other hand milled in the conventional manner. During this step the shrinkage brought about during final sintering is taken into account.

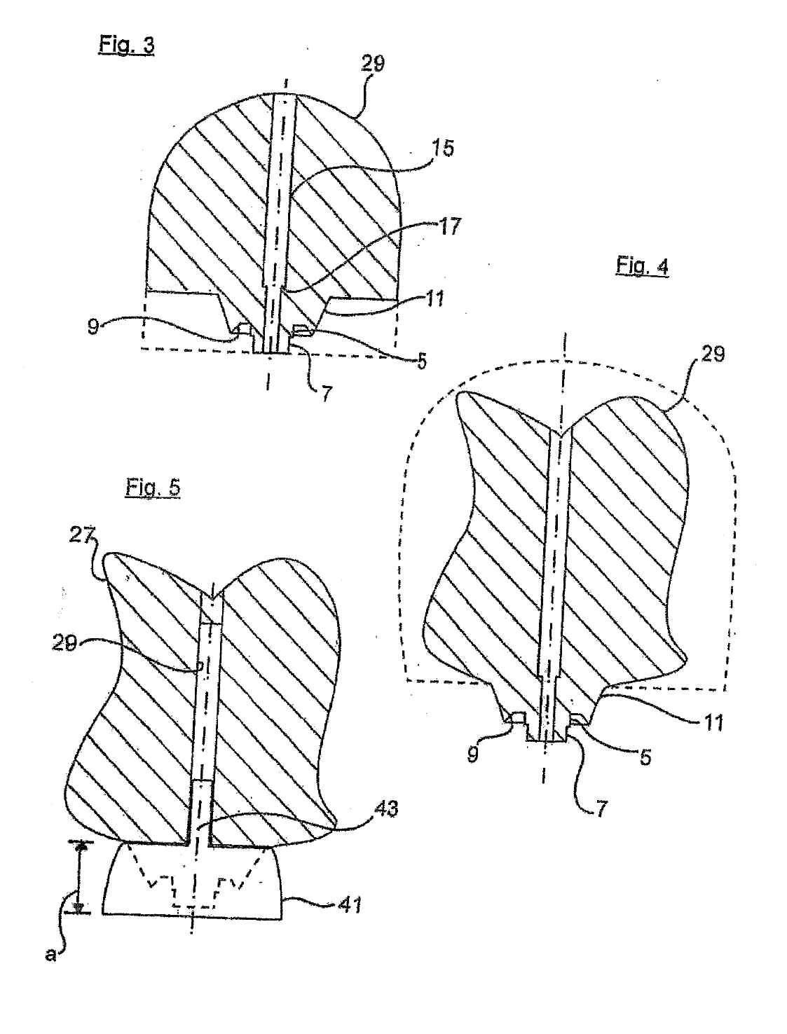

Then, once the ceramic blank 29 has been shaped as shown in FIG. 4, its sintering treatment can be completed.

In this manner the dental technician is enabled on the one hand to shape individually the head piece 1 by means of the positive model 27 while on the other hand fitting it with a high-precision insertion connector that the copy-milling machine would be incapable of producing. Furthermore, in accordance with this process, no machining of the digitalized positive model 27 is required to enlarge the positive model 27 by the necessary amount a. The invention is of special significance for copy-milling machines that are incapable of processing the digitalized positive model electronically. Such copy-milling machines are enabled to apply to the pre-milled ceramic blank 29 the process proposed by the invention, by resorting to the manufacturing kit consisting of the centering template 31 and the scanning insert 41.

Regardless thereof, we should note that the terms copying and copy-milling step include also the process in which the positive model 27 is scanned with the blank stopper 41 in accordance with the state of the art, and subsequently the blank is machined by means of a CAM process on the basis of the digital data so obtained.

Regarding the scanning insert, one should note that it can for example be T-shaped, that is, have the shape of a nail or mushroom. The surface of the head must be larger than the cross-section of the insertion connector once the sintering process is complete. If the insertion connector is surrounded by a previously fashioned rim or collar 63, the head must be wide enough to cover the rim.

FIG. 8 shows scanning insert 50 shaped like a nail or a mushroom. Scanning insert 50, which is also called “cap”, has a disc-shaped head 52: whose surface is greater than the cross-section of the plug-in insert when completely sintered, if need be with this surrounding rim or collar 63, if one has been provided. In order to insert this cap 50 into the lengthwise borehole 28 of the positive model 27, a sleeve-like protrusion 53 emerges from the head consisting of two halves 56, 58 separated by slits 54. By this means the cap 50 is anchored by a force fit in the borehole 28.

The lesson of the invention, namely abutments on which for example a crown is set, or head pieces that encompass a whole crown, need not necessarily have a protruding plug-type extension. Rather anti-twist connections to implants are possible in which the implant has a protruding pin that fits in a matching socket located in the head piece. For this plug-type connection with an inner form closure the lesson of the invention is applicable.

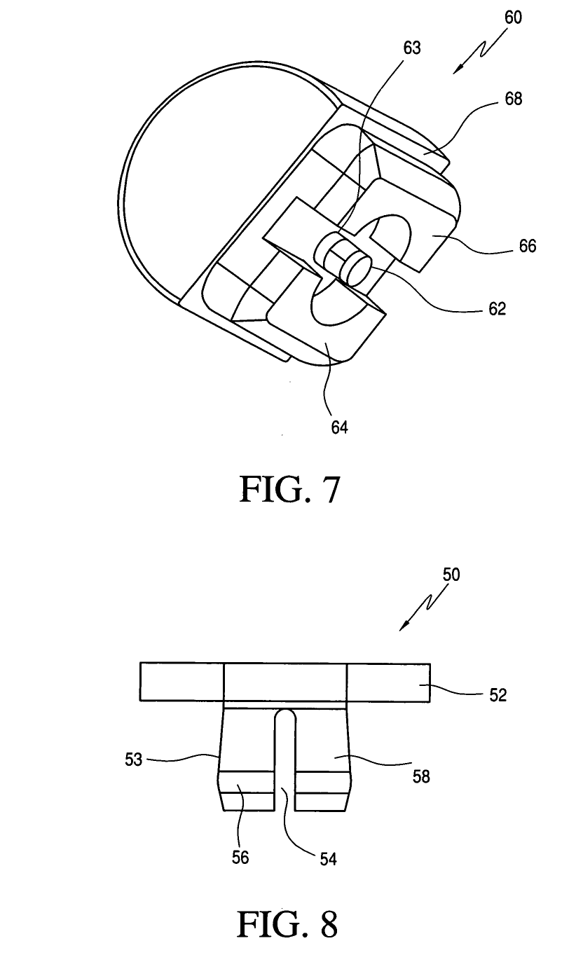

FIG. 7 shows a preferred variant of a pre-sintered ceramic blank 60 that in accordance with the lesson of the invention has a prefashioned and form-closure insertion connector 62.

In order to rule out any damage to the insertion connector 62 it is surrounded by protective sickle-shaped sections 64, 66 that protrude from the lower surface 68 of the blank 60.

The scanning insert that must be inserted into the positive model 27 on which the machining of the blank 60 depends, and inserted specifically into the borehole 28, has the dimensions required so that the data obtained from the positive model 27 and necessary in order to copy-mill the blank or use CAM techniques on it assure removal by milling of sickle-shaped sections 64, 66 without milling the pre-made insertion connector 62.

Sections 64, 65 which in the variant shown are constituted by block-like protuberances that jut out from the base 68 on the connector end and contain the semicircular recesses that concentrically form a circle around the insertion connector 62, serve as protection for the insertion connector 62.

What is claimed is:

1. A process for manufacturing a head piece (1) of a tooth implant from an individually produced positive model (27), the tooth implant comprising a head piece (1) and a base (3) which must be first firmly attached to the jawbone, the head piece (1) being attached to the base (3) by insertion of a lug (5) projecting either from the head piece or from the base and matching a closely fitting socket (21) on the other part, the lug and socket being shaped with a form-closure contour (7) as an anti-twist feature, wherein the head pieces can be made singly, and wherein the outer surface of a positive three-dimensional model (27) of the implant is scanned and a ceramic blank (29, 60) is then copy-milled (V) in accordance with the scan data to make the head piece (1), taking into account shrinkage resulting from sintering,
characterized by the fact that before the copy-milling (V) of the ceramic blank (29, 60), a preparatory step (I) in the production process is performed, in which the blank (29, 60) is in a raw form, and the insertion connector (62) with the form closure (7) is shaped by attaching a scanning insert on the positive model (27) at a point matching the position of the insertion connector on the blank, which enlarges the positive model by at least as much space (a) as that to be occupied by the insertion connector after sintering of the ceramic blank (29, 60).

2. Process according to claim 1, wherein the scanning insert (41) is given the proper size so that the size of the positive model (27) is enlarged by at least the amount (a) of space that the insertion connector occupies on the blank.

3. Process according to claim 1, wherein the positive model (27) is fashioned with a lengthwise borehole (28) by means of which the positive model (27) can for the purpose of individual production be screwed to a model of the surrounding teeth and be adjusted individually.

4. Process according to claim 3, wherein in order to position the positive model (27) in a reference position (A) by means of the lengthwise borehole (28), a centering pin (33) (sic) belonging to a centering template (31) is inserted into the lengthwise borehole (28) of the positive model (27) up to its upper stop (35) and then the centering template (31) together with the positive model (27) is placed on a holding frame (33) of a copy-milling machine.

5. Process according to claim 4, wherein the positive model (27) located in its reference position (A) is fastened with retaining pins (37) to the holding frame (33) and then the centering template (31) is removed from the immobilized positive model (27).

6. Process in accordance with claim 3, wherein the scanning insert (41, 50) that is inserted and held in place as a blank stopper or a cap in the lengthwise borehole (28) of the positive model (27).

7. Process in accordance with claim 1, wherein the as-yet unprocessed ceramic blank (29, 60) is pre-milled independently of the copy-milling machine step (V).

8. Manufacturing kit for producing a head piece (1) of a tooth implant from an individually made positive model (27) by means of a copy-milling machine, wherein the head piece (1) is capable of being plugged into a base part (3) that can be embedded in the jawbone, by means of an insertion connector (62) endowed with form closure (7) as an anti-twist feature, the manufacturing kit comprising a pre-milled ceramic blank (29, 60) from which the head piece (1) can be manufactured using the copy-milling machine on the basis of the positive model (27), the insertion connector of the ceramic blank (29) being fashioned in a previous processing step (I) independently of the copy-milling machine step (V).

9. Kit according to claim 8, having a scanning insert (41, 50) which on the positive model (27) and at a point matching the position of the insertion connector (60) on the blank, is given the proper size so that the size of the positive model (27) is enlarged by at least the space (a) that the pre-milled insertion connector occupies on the blank.

10. Manufacturing kit according to claim 8, having a scanning insert (41, 50) which on the positive model (27) at a point matching the position of the insertion connector (60) on the blank is given the proper size so that the size of the positive model (27) is enlarged by at least the amount (a) that the insertion connector occupies on the completely sintered blank.

11. Manufacturing kit according to claim 8, additionally comprising a centering template (31) for centering the positive model (27) in a holding frame (33) of a copy-milling machine.

12. Manufacturing kit according to claim 11, wherein the centering template (31) is equipped with a centering pin (34) that can be inserted into the lengthwise borehole of the positive model (27).

13. Manufacturing kit according to claim 8, wherein the pre-milled ceramic blank (29, 60) has a lengthwise borehole (15) whose position and size match the lengthwise borehole (28) of the positive model (27).

14. Manufacturing kit according to claim 8, wherein the pre-made insertion connector (62) is afforded protection and is surrounded at least partially by protuberances (64, 66) jutting out from the already sintered ceramic blank (60).

15. Manufacturing kit according to claim 8, wherein the scanning insert is a cap (61) with a head (52) whose surface area is greater than the maximum cross-section of the insertion connector (62).

16. Manufacturing kit according to claim 8, wherein the pre-made insertion connector (62) with the form-closure contour is at least in part designed to be located within the ceramic blank.

17. Manufacturing kit according to claim 8, wherein the connector on the blank can have a pre-manufactured edge or collar, while the size of the surface of connector and rim or collar in the lengthwise axis of the connector and in a completely sintered state is less than the surface of the scanning insert.
